(19) United States
(12) Patent Application Publication
(10) Pub. No.: US 2005/0249152 A1
(43) Pub. Date: Nov. 10, 2005

(54) Method for processing messages

(76) Inventors: Krisztian Kiss, Del Mar, CA (US); Gabor Bajko, Diego, CA (US)

Correspondence Address: ROBERT M BAUER, ESQ.;LACKENBACH SIEGEL, LLP, 1 CHASE ROAD, SCARSDALE, NY, 10583, US

(21) Appl. No.: 11/077,632

(22) Filed: Mar. 10, 2005

Related U.S. Application Data
(60) Provisional application No. 60/568,118, filed on May 4, 2004.

(51) Int. Cl. H04Q 7/00; H04L 12/66

(52) U.S. Cl. 370/328; 370/352

(57) ABSTRACT

The present invention relates to presence (PRES) and instant messaging (IM) services. The invention describes how wireless communication systems can handle messages related to presence and instant messaging services.

This application claims priority to the Provisional Application No. 60/658,118 filed May 4, 2004.

### FIELD OF THE INVENTION

The present invention relates to presence (PRES) and instant messaging (IM) services.

### BACKGROUND TO THE PRESENT INVENTION

Communication systems providing wireless communication for user equipment are known. An example of a wireless system is the public land mobile network (PLMN). PLMNs are commonly based on cellular technology. In cellular systems, a base transceiver station (BTS) or similar access entity services mobile user equipment (UE) via a wireless interface between these entities. The communication on the wireless interface between the user equipment and elements of the communication network can be based on the appropriate communications protocol. The operation of a base station apparatus and other apparatus required for the communication can be controlled by one or several control entities.

One or more gateway nodes may be provided for connecting the cellular access network to other networks, for example to a public switched telephone network (PSTN) and/or other communication networks such as an IP (internet protocol) and/or other packet switched data networks. In such arrangements, the mobile communications network provides an access network enabling a user with wireless user equipment to access external networks, hosts, or services offered by specific service providers.

An example of the type of service that may be offered to a user such as a subscriber to a communication system are so called presence services. Some of the communication systems enabled to offer presence services are known as internet protocol (IP) multimedia networks, via an IP multimedia core network subsystem (IMS). The IMS includes various network entities for the provision of multimedia services. IMS services are intended to offer, amongst other services, IP based packet data communication sessions between mobile user equipment. The packet data can carry presence information. The presence service utilises a server to accept information, store it and distribute it. The information stored may relate for example to the user's willingness to communicate or the capability for communication, or it may be general information relation to the user, or graphic data. The service offers users the opportunity to receive status information relating to one or more other users.

Various types of services are provided by means of different application services (AS) over IMS. The IMS domain is for ensuring that multimedia services are adequately managed. The IMS domain commonly supports the session initiation protocol (SIP) as developed by the internet engineering task force (IETF). The session initiation protocol is an application-layer control protocol for creating, modifying and terminating sessions with one or more participants (end points). SIP was generally developed to allow the initiation of a session between two or more end points in the internet by making these end points aware of the session semantics. A user connected to a SIP based communication system may communicate with various entities of the communication system based on standardised SIP messages.

The session initiation protocol SIP is for example defined in the IETF specification RFC 3261.

Presence services which allow the notification for example about a person's availability or status to be sent directly to a recipient service are currently implemented according to the third generation partnership protocol (3GPP) standards via the session initiation protocol (SIP). In this regard reference is made to the 3GPP IMS/3GPP2 MMD (Multimedia Domain) Presence Service Stage-3 described in the specification 3GPP TS 24.141/3GPP2 X.P0027.2.

In the IETF specification RFC 3859, a common protocol for presence is defined. In particular, this document defines a protocol independent presence PRES URI (universal resource identifier) scheme. The IETF specification RFC 3860 defines a protocol independent instant messaging IM URI scheme. Instant messaging is a means for sending small, simple messages that are delivered immediately to online users. Definitions can be found in RFC 2779/RFC 2778.

Reference is also made to RFC 3861 which describes a mechanism for address resolution for instant messaging and presence services.

Presence user agents (PUA) and so-called watchers may initiate attempts for presence information publication or subscription for presence information state changes as described in the 3GPP documents using the PRES URI scheme. PUA and watchers are logical roles, which may be implemented by UE or application server AS in the IMS network. PUA is an entity publishing presence information, while a watcher is an entity subscribing to presence information state changes. Messaging agents may initiate instant messaging communication, using for example SIP messaging, using the IM URI scheme.

However, the current 3GPP specifications do not disclose or suggest how for example, user equipment can handle the PRES URI scheme and the IM URI scheme.

### SUMMARY OF THE INVENTION

It is therefore an aim of embodiments of the present invention to address the problem with the described systems.

According to a first aspect of the invention, a method for processing messages originating from a wireless station is provided. The method comprises the steps of
receiving a message by a message processing node,
forming a first domain name based on a domain name indicated in the message,
performing a first domain name service query using the first domain name,
if a network address is received as a response to the query, transmitting the message to the received address,
if a network address is not received as a response to the first domain name service query, performing a second domain name service query using the domain name indicated in the message, and
if a network address is received as a response to the second query, transmitting the message to the received address.

The message can be a presence service message.

The message can be an instant messaging service message.

The message processing node can be a call session control function node.

According to a second aspect of the invention, a method for processing messages in a wireless communication network is provided. The method comprises the steps of
receiving a message,
querying a first database for a user identity of the wireless communication network corresponding to identity information indicated in a received message, and
if the message is an instant service message, querying a second database for a network node serving the user identity, and
transmitting the message to the network node serving the user identity.

The method can also comprise the step of transmitting the message to a presence server if the message is a presence service message.

The second database can be a home subscriber server.

The network node serving the user identity can be a serving call session control function node.

According to a third aspect of the invention, a network node for a wireless communication system is provided. The network node comprises
means for receiving a message,
means for constructing a first domain name based on a domain name indicated in a message,
means for performing a domain name system query,
means for transmitting a message to a network address obtained from a domain name system query,
means for determining a user identity from a received message, and
means for querying a database for determining a user identity within the wireless communication system based on a user identity from a received message.

The network node can further comprise means for publishing resource records in a domain name service system.

According to a fourth aspect of the invention a system for a wireless communication network is provided. The system comprises
a database for storing user identification information for a messaging protocol and corresponding user identities for the wireless communication network,
means for publication of resource records in a domain name service system,
means for receiving a message,
means for constructing a first domain name based on a domain name indicated in a message,
means for performing a domain name system query,
means for transmitting a message to a network address obtained from a domain name system query,
means for determining a user identity from a received message, and
means for querying a database for a user identity of the wireless communication system corresponding to user identification information indicated in a received message.

The system can further comprise a protocol gateway node.

The system can further comprise a presence server node.

### BRIEF DESCRIPTION OF DRAWINGS

For a better understanding of the present invention and as to how the same may be carried into effect, reference will now be made by way of example only to the accompanying drawings in which:

FIG. 1 is a schematic diagram of an architecture supporting presence services;

FIG. 2 is a schematic diagram illustrating message exchange in a first embodiment of the present invention;

FIG. 3 is a schematic diagram illustrating message exchange in a second embodiment of the present invention; and

FIG. 4 is a schematic diagram illustrating message exchange in a further embodiment of the present invention.

### DETAILED DESCRIPTION OF PREFERRED EMBODIMENTS

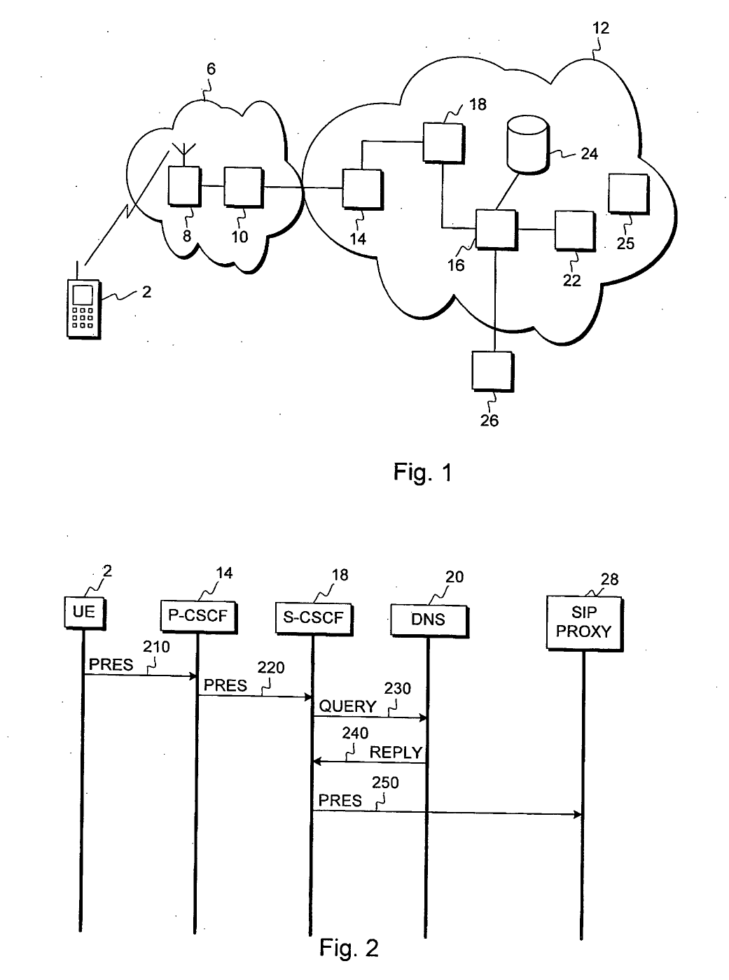

FIG. 1 is a schematic diagram illustrating an architecture extension of the 3GPP IMS (IP Multimedia Subsystem)/3GPP2 MMD (Multimedia Domain) defined in 3GPP TS 23.228/3GPP2 X.P0013-002 respectively which can be used to support PRES and IM URI schemas. Certain embodiments of the present invention will be described by way of example with reference to the exemplifying architecture of a third generation (3G) mobile communication system. However, it would be understood that embodiments of the present invention may be applied to any other suitable form of communication systems.

The third generation partnership project (3GPP) has defined reference architecture for the third generation (3G) core network which will provide the users of user equipment with access to multimedia and presence services. This core network is divided into three principal domains. These are the circuit switched domain packet, the packet switched domain and the internet protocol multimedia subsystem (IMS) domain.

User equipment 2 is arranged to communicate via a radio interface 4 with a radio access network (RAN) 6. The radio access network comprises a base transceiver station 8. The radio access network 6 in practice will comprise a number of base transceiver stations although only one is shown in FIG. 1 for clarity. The user equipment is arranged to communicate with the base transceiver station 8. The radio access network 6 also comprises at least one radio network controller RNC 10. Each RNC 10 is arranged to control a plurality of base transceiver stations 8. The RAN 6 is connected to an IMS domain.

The IMS 12 domain comprises a number of call session control functions CSCF. The call session control functions can be divided into various categories such as a proxy call session control function (P-CSCF) 14, an interrogating call session control function (I-CSCF) 16, and a serving call session control function (S-CSCF) 18. In practice there will be many more of these CSCFs which have been omitted for clarity. In the IMS 12, the P-CSCF 14 is connected to the S-CSCF 18. The S-CSCF 18 is connected to the I-CSCF 16. The I-CSCF may be in the same IMS domain or in a different IMS domain.

The IMS 12 can be connected to a domain name server (not shown). The functionalities of the domain name server can also be provided by a node of the IMS 12, by a dedicated DNS server node or as one service provided by a node.

The IMS 12 also contains in the example of FIG. 1 a protocol gateway 22. The IMS 12 may also contain a SIP proxy.

A mapping database 24 is also provided. This mapping database may be in the IMS 12 domain or external there to, i.e. it can be located in a core network (CN) or for example another IMS.

FIG. 1 also illustrates a SIP client 26, which in this example is an external client, i.e. external to the IMS 12. The SIP client may be any SIP client, such as an external non-IMS SIP client or an IMS client.

FIG. 1 also illustrates a presence server 25 in the IMS. Connections between the presence server and other nodes in the IMS are not explicitly illustrated in FIG. 1 for clarity. The presence server 25 can also be located outside the IMS 12, for example in another IMS or in another network.

It should be appreciated that the system shown in FIG. 1 is not comprehensive but shows those elements involved in embodiments of the present invention. It should also be appreciated that the connections between the various entities shown in FIG. 1 may be different in alternative embodiments of the present invention. In some embodiments of the present invention, some of the elements may be omitted.

Embodiments of the present invention are arranged to allow a user equipment to address a request using a PRES URI or an IM URI. Thus, the behaviour defined in the 3GPP specifications discussed previously needs to be modified.

FIG. 2 shows a signal flow in an embodiment of the present invention. The example shown in FIG. 2 shows an example using a PRES URI. However it should be appreciated that this signal flow can also be used with IM URI request. Those elements shown in FIG. 2 which are the same as those in FIG. 1 are referenced by the same reference numerals.

When the user equipment 2 generates either:
1. A SIP PUBLISH or a SIP SUBSCRIBE request using a PRES: URI in the Request-URI, for example pres: Joe@example.com or
2. A SIP MESSAGE or a SIP INVITE request using an IM: URI in the Request-URI, for example im:Joe@example.com.
   then in step 210, the request is forwarded to the P-CSCF 14.

In step 220, the request received by the P-CSCF 14 from the UE 2 in step 210 is routed to the S-CSCF 18. This can be done in accordance with standard IMS routing behaviour utilising the SIP service-route extension, i.e. the UE indicates the S-CSCF in a header field in the request.

In step 230, when the S-CSCF receives the request from the P-CSCF specifying either a PRES: URI or an IM: URI in the Request-URI, the S-CSCF will send a query in step 230 to a DNS server 20. In other words, a DNS look up is performed on the request URI. The look up first attempts to locate a SRV RR (service resource record) associated with the domain of the URI, such as a _pres._sip.example.com RR. If such a RR is not found, S-CSCF performs a look up for the domain name example.com. DNS servers will follow the standard procedures in RFC 2782, and the functioning of the DNS system is therefore not described here in any further detail. In step 240, the DNS server returns a reply to the query. In step 250, S-CSCF transmits the message to the node found in the DNS query, in the example of FIG. 2 to an external SIP proxy. The destination could also be a presence server in the same or another IMS, or a presence server in another network.

Depending on the protocol the other end implements (the other end point is represented by the URI in the Request-URI), the returned DNS response could point to: a protocol gateway (either inside the same IMS/MMD network or outside) if the other endpoint implements a presence/IM protocol other than SIP/SIMPLE; a SIP proxy outside the IMS/MMD network if the other endpoint implements SIP/SIMPLE but not an IMS endpoint; another IMS/MMD networks I-CSCF if the other endpoint is an IMS endpoint in another domain; or an I-CSCF inside the same IMS/MMD network if the other endpoint is an IMS endpoint in another domain.

For example, if the request type in URI contains pres:joe@example.com the S-CSCF will first attempt to locate the resource record (DNS RR) _pres._sip.example.com. Generally, if the target system supports SIP for presence services, it will publish a _pres._sip resource record pointing to a node which can process SIP messages associated with presence services. The node can be a SIP server. If the target system does not support presence services using SIP but some other protocol, the target system can provide a protocol gateway for translating between PRES SIP and the locally supported protocol, in which case the system can publish a _pres._sip RR pointing to the protocol gateway.

Resource records indicating instant message service can be construed in a similar way. For example, if the request type in URI contains im:joe@example.com the S-CSCF will first attempt to locate the resource record (DNS RR) _im._sip.example.com.

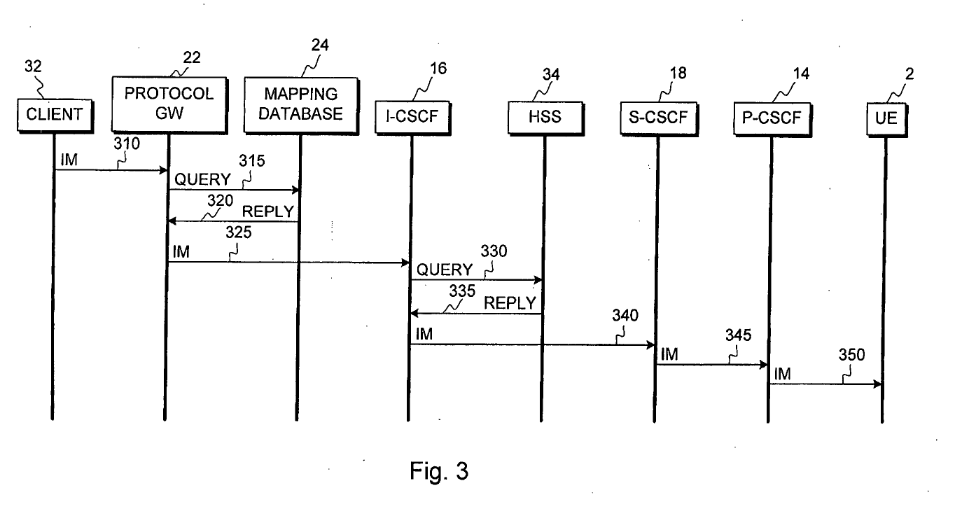

Reference is now made to FIG. 3 which shows a signal flow in a further embodiment of the present invention. The signal flow illustrated in FIG. 3 illustrates how IMS users can be addressable with an IM URI.

DNS service resource records (SRV RR) pointing to the entry point of that specific IMS network are published by the IMS in the DNS system. The entry point can be an I-CSCF, in which case a resource record pointing to that I-CSCF is published. In such a case, the I-CSCF is advantageously arranged to support the use of SIP protocol for presence and instant messaging services. The entry point can also be a protocol gateway capable of translating between protocols, in which case a resource record pointing to that protocol gateway is published. Preferably, a resource record is published for each instant messaging or presence service protocol supported by the protocol gateway.

In the example of FIG. 3, an instant messaging client 32 sends an instant message (IM) to a protocol gateway 22 in step 310. In this example, the instant messaging client 32 uses a protocol which is not supported internally by the IMS, but supported by the protocol gateway 22 of the IMS. The instant messaging client is able to find the protocol gateway via a resource record published by the IMS, pointing to the protocol gateway. The protocol gateway 22 sends 315 a query to the mapping database 24 to discover an IMS public user identity corresponding to the IM URI given in the message received from the client 32. Next, the mapping database 24 responds 320 with a reply to the query, indicating a corresponding IMS public user identity. In step 325, the protocol gateway 22 transmits the message to an I-CSCF 16 using a protocol supported internally by the IMS, such as the SIP protocol, and indicating the discovered IMS public user identity. Next, the I-CSCF queries 330 a home subscriber server (HSS) 34 to find the S-CSCF serving the UE 2 associated with the IMS public user identity. The HSS 34 replies 335 indicating the correct S-CSCF, whereafter the I-CSCF transmits 340 the message to the S-CSCF 18. The S-CSCF routes 345 the message to the P-CSCF 14, which in turn routes 350 the message to the UE 2.

In a case in which the external client 32 uses an instant messaging protocol supported directly by an I-CSCF, the signalling can be slightly different from that of FIG. 3. In such a case, the external client 32 transmits the instant message directly to the I-CSCF. The external client is able to do this, since the in this example the IMS publishes a DNS resource record indicating support for that protocol and pointing to the I-CSCF. In the case of supporting instant messaging using the SIP protocol, such a resource record could be of the form _im._sip.example.com. Upon receiving the message, the I-CSCF finds out the corresponding IMS public user identity by querying the mapping database. After finding out the IMS public user identity, the I-CSCF continues by querying the HSS 34 as shown in FIG. 3.

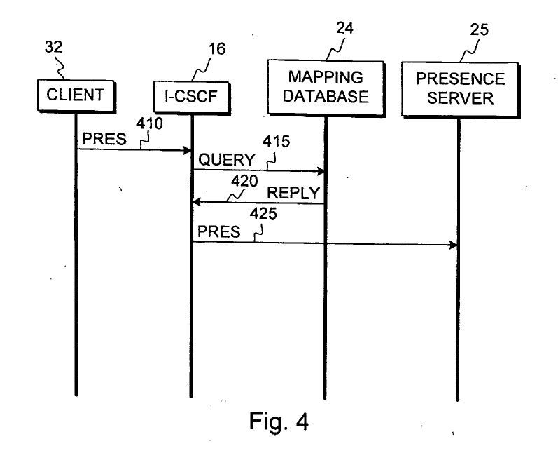

FIG. 4 illustrates a possibility to provide signalling in a case, where a presence service message is addressed to the IMS. In step 410 a client 32 transmits a presence service message to the I-CSCF 16. As described previously, the client 32 is able to do that as the IMS publishes a DNS resource record pointing to the I-CSCF. The client 32 can be an external or an internal client in relation to the IMS. After receiving the message, the I-CSCF queries 415 a mapping database to find out an IMS public user identity corresponding to the identity information indicated in the message. The mapping database transmits 420 a reply indicating an IMS public user identity. In step 425, the I-CSCF transmits the message to a presence server 25 in the IMS, indicating the IMS public user identity.

In a further embodiment of the invention, before the step 425 of transmitting the message to a presence server, the I-CSCF queries a database to find out which presence server manages presence status information associated with the IMS public user identity. The database can be for example a home subscriber server (HSS).

The RRs may be provided e.g. by the carrier system. The mappings may be entered into the mapping database e.g. at the time of subscribing.

It is noted that while the preceding description illustrates various embodiments of the invention within a 3G cellular telecommunications system, the invention is not limited to a so called 3G cellular system, but can be implemented in different types of cellular telecommunication systems as well.

Although described in the context of particular embodiments, it will be apparent to those skilled in the art that a number of modification and various changes to these teachings may occur. Thus while the invention have been particularly shown and described with respect to the one or more preferred embodiments thereof, it will be understood by those skilled in the art that various modifications and changes may be made without departing from the spirit or scope of the invention described herein.

1. Method for processing messages originating from a wireless station comprising the steps of
receiving a message by a message processing node,
forming a first domain name based on a domain name indicated in the message,
performing a first domain name service query using the first domain name,
if a network address is received as a response to the query, transmitting the message to the received address,
if a network address is not received as a response to the first domain name service query, performing a second domain name service query using the domain name indicated in the message, and
if a network address is received as a response to the second query, transmitting the message to the received address.

2. A method according to claim 1, wherein the message is a presence service message.

3. A method according to claim 1, wherein the message is an instant messaging service message.

4. A method according to claim 1, wherein the message processing node is a call session control function node.

5. Method for processing messages in a wireless communication network comprising the steps of
receiving a message,
querying a first database for a user identity of the wireless communication network corresponding to identity information indicated in a received message, and
if the message is an instant service message, querying a second database for a network node serving the user identity, and
transmitting the message to the network node serving the user identity.

6. Method according to claim 5, comprising the step of
transmitting the message to a presence server if the message is a presence service message.

7. Method according to claim 5, wherein the second database is a home subscriber server.

8. Method according to claim 5, wherein the network node serving the user identity is a serving call session control function node.

9. Network node for a wireless communication system, comprising
means for receiving a message,
means for constructing a first domain name based on a domain name indicated in a message,
means for performing a domain name system query,
means for transmitting a message to a network address obtained from a domain name system query,
means for determining a user identity from a received message, and
means for querying a database for determining a user identity within the wireless communication system based on a user identity from a received message.

10. Network node according to claim 9, further comprising means for publishing resource records in a domain name service system.

11. System for a wireless communication network, comprising
a database for storing user identification information for a messaging protocol and corresponding user identities for the wireless communication network,
means for publication of resource records in a domain name service system,
means for receiving a message,
means for constructing a first domain name based on a domain name indicated in a message,
means for performing a domain name system query,
means for transmitting a message to a network address obtained from a domain name system query,
means for determining a user identity from a received message, and
means for querying a database for a user identity of the wireless communication system corresponding to user identification information indicated in a received message.

12. A system according to claim 11, further comprising a protocol gateway node.

13. A system according to claim 11, further comprising a presence server node.
